(19) United States
(12) Patent Application Publication
(10) Pub. No.: US 2007/0127883 A1
(43) Pub. Date: Jun. 7, 2007

(54) Digital multimedia broadcasting receiver, image-forming system having the same, and image-forming method thereof

(75) Inventor: Chong-wan Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/591,460

(22) Filed: Nov. 2, 2006

(30) Foreign Application Priority Data
Dec. 2, 2005 (KR) 2005-116886

(51) Int. Cl. H04N 5/91

(52) U.S. Cl. 386/83

(57) ABSTRACT

A digital multimedia broadcasting (DMB) receiver is provided in an image-forming. Such a DMB receiver comprises: a receiving unit for receiving DMB signals; a data storage unit for converting the received DMB signals to image data and storing the converted image data; and a connection unit arranged to interface with an image-forming device. Accordingly, when a user watches broadcasting programs using the DMB receiver, the user can easily capture or record desired scene(s) and store the captured or recorded scene(s) as an image file or a video file. In addition, by connecting the DMB receiver to the image-forming device, image data stored in the storage medium can be easily printed.

### CROSS-REFERENCE TO RELATED APPLICATIONS

This application claims all benefits accruing under 35 U.S.C. §119 from Korean Application No. 2005-116886, filed Dec. 2, 2005, in the Korean Intellectual Property Office, the disclosure of which is incorporated herein by reference.

### BACKGROUND OF THE INVENTION

1. Field of the Invention

The present invention relates to a digital multimedia broadcasting, and more particularly, to a digital multimedia broadcasting (DMB) receiver which is portable, converts a predetermined received signal to image data and stores the converted image data in a storage medium, and can be plugged into an image-forming device.

2. Related Art

As mobility of digital devices has improved, research on digital multimedia broadcasting (DMB) and digital audio broadcasting (DAB), which enable users to receive broadcasts of multimedia, via mobile devices, has been conducted. Digital multimedia broadcasting (DMB) is a digital radio transmission system for sending multimedia, such as radio, TV and data, to mobile devices, such as mobile phones, laptops and portable multimedia devices. The term DMB is coined by the Korea Broadcasting Commission (KBC) and Ministry of Information Communication (MIC). In the comprehensive plan for digital broadcast, data broadcast, and DMB) announced in 2003, the Korean Broadcasting Commission (KBC) defines DMB as “a digital multimedia broadcast that can provide CD-quality and image-quality data, and high-quality non-mobile and mobile data transmissions”.

Digital multimedia broadcasting (DMB) is also known as the next generation mobile multimedia broadcasting service since a user can enjoy a CD-level sound quality and data service and watch multi-channel multimedia broadcasting programs through a mobile device, such as a mobile phone, a personal digital assistance (PDA), a laptop, a portable multimedia device, or even an in-car DMB receiver while moving.

DMB is classified into ground or terrestrial DMB (T-DMB), and satellite DMB (S-DMB) according to a transmission system and a network configuration.

T-DMB employs Eureka-147, which is a technical standard of Europe digital audio broadcasting (DAB), as a fundamental specification. For T-DMB, multimedia broadcasting for mobile receivers is transmitted using a very high frequency (VHF) channel No. 12, in which three blocks are obtained by splitting a single channel, and several video/audio channels per block are obtained. A frequency band of the T-DMB is 174-216 MHz, and an MPEG-4 (Moving Picture Experts Group-4) technique is used for a compression scheme. Electronic waves of the frequency band have a diffraction characteristic to accommodate long-distance propagation. A T-DMB service is designed for users, primarily in vehicles, and its reception fee is intended to be free for all users.

Unlike T-DMB, S-DMB transmits broadcasting signals using a satellite. Thus, in a downtown area having a low reception rate, broadcasting signals are received using a relay station, called a gap filler. A frequency band of S-DMB is more than 2,605 GHz, and a compression scheme is the same as that of T-DMB. The number of channels is about 20 for video and about 50 for audio. S-DMB is mainly operated for portable terminals, such as mobile phones, and the reception fee is constant. Electronic waves of the frequency band have a straightforward characteristic.

According to a conventional DMB receiver, when a user watches broadcasting programs through the conventional DMB receiver, the user cannot simply store an image or video file obtained by capturing or recording desired scene(s). As a result, additional application, receiver, and inter-device connection are necessary.

In addition, when the user wants to print a desired scene, while watching broadcasting programs, a series of complex procedures must be performed, thereby causing inconvenience to the user.

### SUMMARY OF THE INVENTION

Several aspects and example embodiments of the present invention provide a digital multimedia broadcasting (DMB) receiver which is portable, converts a predetermined received signal to image data and stores the converted image data in a storage medium, and is dockable with an image-forming device. Aspects of the present invention also provide an image-forming system, which is connected to the DMB receiver and which prints image data stored in a storage medium and an image-forming method thereof.

Additional aspects and/or advantages of the invention will be set forth in part in the description which follows and, in part, will be obvious from the description, or may be learned by practice of the invention.

In accordance with an embodiment of the present invention, there is provided a digital multimedia broadcasting (DMB) receiver comprising: a receiving unit arranged to receive DMB signals; a data storage unit arranged to convert the received DMB signals to image data and store the converted image data; and a connection unit arranged to interface with an image-forming device.

According to an aspect of the present invention, the DMB receiver may further comprise a plugging unit allowing the DMB receiver to be plugged into the image-forming device. The plugging unit may have one of a docking structure, a slide structure, and a built-in structure.

According to an aspect of the present invention, the data storage unit may comprise: a storage medium for storing image data; and a data writer for converting the received DMB signals to image data and writing the converted image data to the storage medium. Such a data storage unit may further comprise a first selection unit for allowing a user to select one of the received DMB signals to be stored in the storage medium.

According to an aspect of the present invention, the DMB receiver may further comprise an external device controller for controlling the image-forming device to print the stored image data. The DMB receiver may further comprise a second selection unit for allowing the user to select image data to be printed among the image data stored in the data storage unit.

According to an aspect of the present invention, the DMB receiver may further comprise a display panel for providing a visual display of broadcasting programs corresponding to the received DMB signals, including scenes to be selected by a user for a printing operation; and an operation panel for enabling a user to control operation of the DMB receiver.

According to an aspect of the present invention, the image data may be a video or image file. The DMB receiver can be portable or mobile.

In accordance with another embodiment of the present invention, there is provided an image-forming system comprising: a receiving terminal arranged to receive digital multimedia broadcasting (DMB) signals, convert received DMB signals to image data, and store converted image data; and a printing unit arranged to print the image data.

According to an aspect of the present invention, the receiving terminal may be pluggable. The receiving terminal may be pluggable using one of a docking structure, a slide structure, and a built-in structure.

According to an aspect of the present invention, the image-forming system may further comprise a display unit for providing a visual display of broadcasting programs corresponding to the received DMB signals; and a first selection unit for allowing a user to select one of the received DMB signal to be stored on a storage medium.

According to an aspect of the present invention, the receiving terminal may comprise: a receiving unit arranged to receive a DMB signal; a storage medium to store image data; and a data writer arranged to convert the received DMB signal to image data and write the converted image data to the storage medium.

According to an aspect of the present invention, the printing unit may read and print image data stored in the storage medium.

According to an aspect of the present invention, the image-forming system may further comprise a second selection unit for allowing the user to select one of the image data stored in the storage medium to be printed on a printable medium. The image data may be a video or image file.

In accordance with yet another embodiment of the present invention, there is provided an image-forming method comprising: receiving DMB signals using a digital multimedia broadcasting (DMB) receiver that can be plugged into an image-forming device; converting a predetermined signal of the received DMB signals to image data and storing the converted image data; and printing the stored image data.

According to an aspect of the present invention, the converted image data may be stored in a storage medium included in the DMB receiver.

According to an aspect of the present invention, the image-forming method may further comprise displaying a broadcasting program corresponding to the received DMB signals; and allowing a user to select one of the received DMB signal to be stored on a storage medium.

According to an aspect of the present invention, the image-forming method may further comprise the DMB receiver arranged to control the image-forming device to print the stored image data. The image-forming device may read and print image data stored in the DMB receiver.

According to an aspect of the present invention, the image-forming method may further comprise allowing the user to select one of the stored image data to be printed on a printable medium. The DMB receiver may be pluggable using one of a docking structure, a slide structure, and a built-in structure. The image data may be a video or image file.

According to another aspect of the present invention, there is provided a computer readable recording medium storing a computer readable program for executing the image-forming method.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an example digital multimedia broadcasting (DMB) receiver according to an embodiment of the present invention;

FIG. 2 is a block diagram of an example image-forming system according to an embodiment of the present invention;

FIG. 3 is a flowchart of a method of storing image data in a DMB receiver in an image-forming method according to an embodiment of the present invention;

FIG. 4 is a flowchart illustrating a method of printing image data using an image-forming method according to an embodiment of the present invention;

FIG. 5 is a perspective view of an image-forming device in which a DMB receiver is equipped using a built-in structure, according to an embodiment of the present invention;

FIG. 6 is a photographic perspective view of an image-forming device having a docking structure for docking a DMB receiver, according to an embodiment of the present invention;

FIG. 7 is a photographic perspective view of an image-forming device with which a DMB receiver having a display panel is docked using a docking structure, according to an embodiment of the present invention;

FIG. 8 is a photographic perspective view of an image-forming device with which a mobile phone supporting a DMB receiving function is docked using a docking structure, according to an embodiment of the present invention; and

FIG. 9 is a photographic perspective view of an image-forming device and a DMB receiver connected to each other using a wired scheme, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

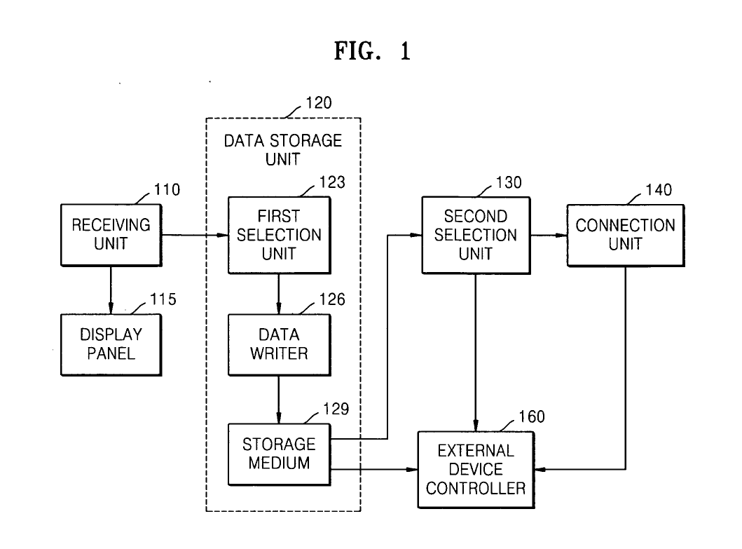

FIG. 1 is a block diagram of a digital multimedia broadcasting (DMB) receiver according to an embodiment of the present invention. Such a DMB receiver can be a stand-alone device or an in-car DMB receiver installed in a vehicle, or alternatively, can be incorporated into a mobile device, such as a mobile phone, a personal digital assistance (PDA), a laptop, and a portable multimedia device, to receive broadcast signals from a DMB system (i.e., DMB signals). As shown in FIG. 1, the DMB receiver includes a receiving unit 110, a data storage unit 120, and a connection unit 140. The DMB receiver may further include a display panel 115, a second selection unit 130, and an external device controller 160.

The receiving unit 110 receives DMB signals. The display panel 115 displays a broadcasting program corresponding to the DMB signals received by the receiving unit 110, information required to control the DMB receiver, and a user interface related to preview, image editing, or folder management with respect to image data stored in the data storage unit 120.

The data storage unit 120 includes a data writer 126 and a storage medium 129, and serves to convert the DMB signals received by the receiving unit 110 into image data having a predetermined format and stores the converted image data in the storage medium 129. The image data can represent an image file, in common image file formats, such as JPG (Joint Photographic Experts Group), TIF (Tag Image File), or GIF (Graphic Interchange Format), captured and converted at a specific time, or a video file, in AVI (Audio Video Interleave) or MPG (Moving Picture Experts Group) format, recorded and converted for a predetermined time.

The data storage unit 120 may further include a first selection unit 123 arranged to enable a user to select one of the DMB signals received by the receiving unit 110 to be stored in the storage medium 129. The first selection unit 123 allows the user to specify a DMB signal received by the receiving unit 110 at a specific time or for a predetermined time desired by the user using an operation panel (not shown). For example, when the user wants to capture a specific scene and store the desired scene(s) as an image file, while watching a broadcasting program displayed on the display panel 115, the user clicks a predetermined button, and when the user wants to record images displayed on the display panel 115 for a predetermined time, the user clicks a predetermined button at each of a recording start time and a recording end time.

The data writer 126 converts the DMB signal selected through the first selection unit 123 to image data and stores the converted image data in the storage medium 129. The storage medium 129 can be any recording medium to store image data, including a memory, such as, a dynamic or static random access memory (DRAM or SRAM), erasable and programmable read-only memories (EPROMs), an electrically erasable and programmable read-only memory (EEPROM) and a flash memory, or a hard disk drive (HDD) and other magnetic or optical media such as compact discs (CDs) or digital video discs (DVDs).

The second selection unit 130 allows the user to select image data to be printed among image data stored in the storage medium 129. For example, the second selection unit 130 provides to the user information regarding the image data stored in the storage medium 129 using a preview user interface or viewfinder displayed on the display panel 115 and allows the user to select the image data to be printed through the operation panel.

The connection unit 140 is connected to and interfaces with an image-forming device (not shown). The connection unit 140 may use a wired scheme, such as a universal serial bus (USB) cable, a connector, or a connection terminal, or a wireless scheme, such as Bluetooth or Infrared data arrangement (IrDA) to connect and interface with the image-forming device (not shown).

In addition, a plugging unit (not shown) may also be included to enable the DMB receiver, as shown in FIG. 1, to be plugged into an image-forming device (not shown) for printing or forming an image representing desired scene(s) selected by the user on a printable medium, such as a photo paper. Such a plugging unit may be implemented using a built-in structure in which a space inside the image-forming device (not shown) is prepared to accommodate the DMB receiver, and the DMB receiver, as shown in FIG. 1, is electrically connected to the image-forming device (not shown) using a connector or connection terminal included in the connection unit 140. Alternatively, such a plugging unit (not shown) may be implemented using a docking structure in which the DMB receiver can be plugged into the image-forming device (not shown) through a connector or using a slide structure in which the DMB receiver can be plugged into the image-forming device through a connection terminal.

The DMB receiver is portable. Thus, the user can watch broadcasting programs by connecting the DMB receiver to another display panel equipped device. Alternatively, the user can watch broadcasting programs using the DMB receiver equipped with the display panel 115 while moving. The DMB receiver may be connected to another device and transmit image data stored in the storage medium 129 to the other device.

The external device controller 160 controls the image-forming device (not shown) using the connection unit 140 to print the image data selected through the second selection unit 130.

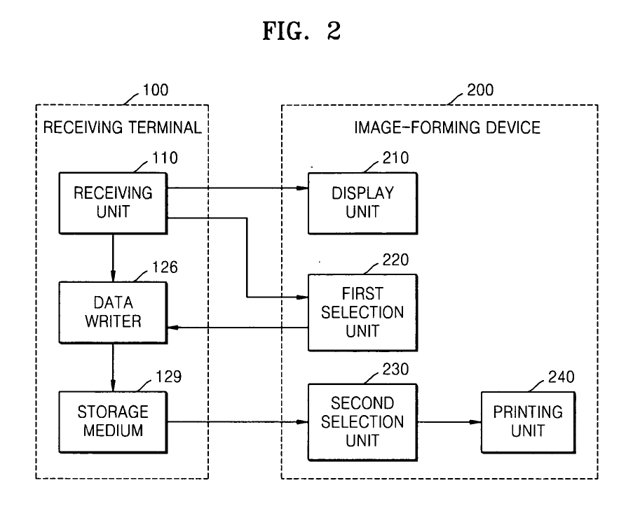

Turning now to FIG. 2, a block diagram of an image-forming system according to an embodiment of the present invention is illustrated. As shown in FIG. 2, the image-forming system includes a receiving terminal 100 and an image-forming device 200.

The receiving terminal 100 includes a receiving unit 110, a data writer 126, and a storage medium 129. The image-forming device 200 includes a display unit 210, a first selection unit 220, a second selection unit 230, and a printing unit 240.

The receiving terminal 100 including the receiving unit 110, the data writer 126, and the storage medium 129 operates in the same way as the DMB receiver shown in FIG. 1. However, selected components of the DMB receiver, as shown in FIG. 1, can be omitted, particularly if these components reside in the image-forming device. For example, since the image-forming device 200 is provided with a display unit 210, a first selection unit 220, a second selection unit 230 along with a printing unit 240, the receiving terminal 100 needs not be provided with a separate display panel or the same first and second selection units, as shown in FIG. 1. Rather, the display unit 210 included in the image-forming device 200 may operate in the same way as the display panel 115 shown in FIG. 1. Similarly, the first selection unit 220 included in the image-forming device 200 may operate in the same way as the first selection unit 123 shown in FIG. 1. Likewise, the second selection unit 230 included in the image-forming device 200 may operate in the same way as the second selection unit 130 shown in FIG. 1.

Alternatively, the display unit 210, the first selection unit 220, and/or the second selection unit 230 may also be included in the receiving terminal 100.

The printing unit 240 prints image data selected through the second selection unit 230 on a printing medium, such as paper or a specific medium.

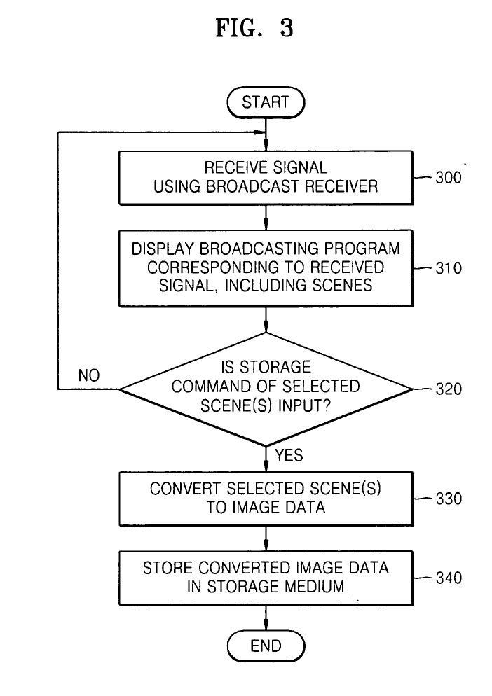

FIG. 3 is a flowchart illustrating a method of storing image data in a DMB receiver using an image-forming method according to an embodiment of the present invention. In the image-forming method according to the current embodiment of the present invention, the DMB receiver, as shown, for example, in FIG. 1 and FIG. 2, can be plugged into an image-forming device 200, shown in FIG. 2, and includes a storage medium for storing image data.

Referring to FIG. 3, a broadcast signal is received using the DMB receiver at operation 300. A broadcasting program corresponding to the received broadcast signal is displayed on a display panel 115 included in the DMB receiver, as shown in FIG. 1, or a display unit 210 included in the image-forming device 200, as shown in FIG. 2, at operation 310.

In operation 320, the DMB receiver determines if a user inputs a storage command relating to selected scene(s) of the broadcasting program displayed on the display panel 115 included in the DMB receiver, as shown in FIG. 1, or the display unit 210 included in the image-forming device 200, as shown in FIG. 2. The user inputs a storage command using a predetermined command method of clicking a predetermined button on an operation panel (not shown) at a specific time or clicking the operation panel for a predetermined time.

If the user inputs a storage command, the selected scene(s) is converted to image data having a predetermined format at operation 330. Here, the image data is an image file, in JPG, TIF, or GIF format, captured and converted at a specific time or a video file, in AVI or MPG format, recorded and converted for a predetermined time.

The converted image data is the stored in the storage medium 129, as shown, for example, in FIG. 1 and FIG. 2, at operation 340.

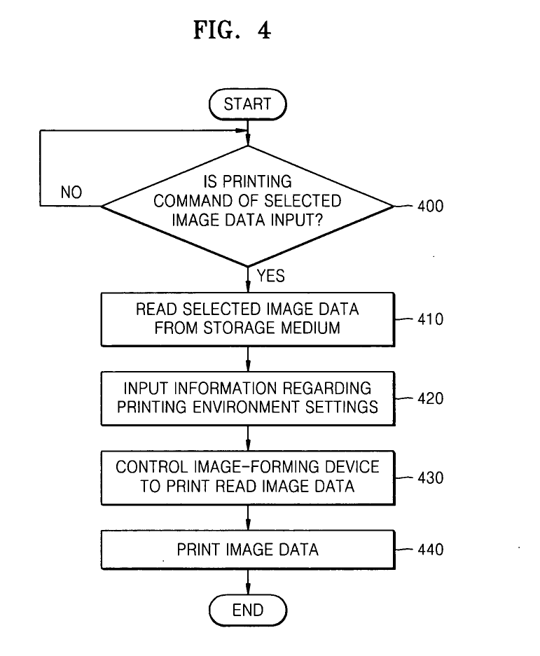

FIG. 4 is a flowchart illustrating a method of printing image data using an image-forming method according to an embodiment of the present invention. In the image-forming method, a DMB receiver, as shown in FIG. 1 and FIG. 2, includes a storage medium for storing image data, and can be directly plugged into an image-forming device 200, as shown in FIG. 2, or connected to the image-forming device 200 through a cable.

Referring to FIG. 4, at operation 400, when a user selects image data representing one or more selected scenes from the broadcasting program to be printed among image data stored in the storage medium, the DMB receiver determines if a printing command of the image data to be printed is input from a user. Here, information regarding the image data stored in the storage medium 129 is provided to the user using a preview user interface or viewfinder displayed on a display panel 115 included in the DMB receiver, as shown in FIG. 1, or a display unit 210 included in the image-forming device 200, as shown in FIG. 2, and the image data to be printed is selected by the user through an operation panel (not shown).

If a printing command is input from a user, the image data selected by the user is read from the storage medium 129 at operation 410. Information regarding printing environment settings is then input at operation 420.

At operation 430, the DMB receiver, as shown in FIG. 1 or FIG. 2, controls the image-forming device 200, as shown in FIG. 2, to print the image data read at operation 410 according to the printing environment settings input at operation 420.

At operation 440, the image-forming device 200 connected to the DMB receiver prints the image data selected at operation 410 according to the control at operation 430.

In another embodiment of the present invention, at operations 430 and 440, the image-forming device 200, as shown in FIG. 2, may read image data from the storage medium included in the DMB receiver and print the read image data.

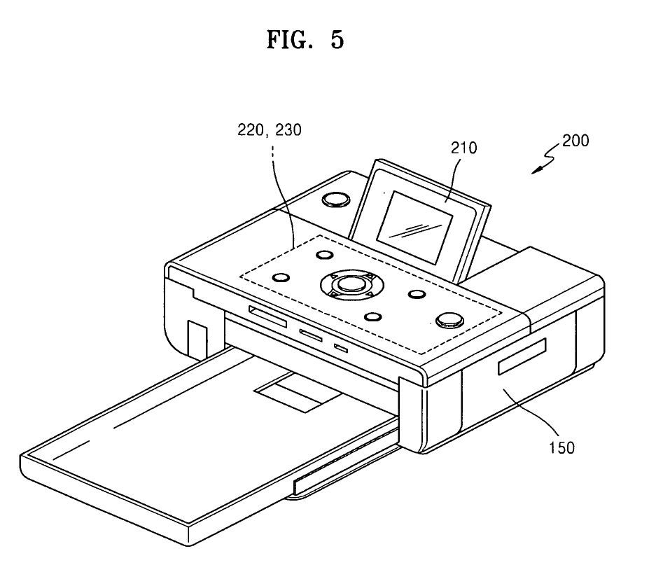

FIG. 5 is a perspective view of an image-forming device 200 in which a DMB receiver is equipped using a built-in structure, according to an embodiment of the present invention. In the built-in structure, a space to accommodate the DMB receiver is prepared inside the image-forming device 200. If the DMB receiver is installed inside the image-forming device 200, a connection unit 140 included in the DMB receiver, as shown in FIG. 1, is physically connected to a connection unit (not shown) included in the image-forming device 200. Alternatively, the DMB receiver and the image-forming device 200 may be connected, via the connection unit 140, shown in FIG. 1. A plugging unit 150 is built-in an image-forming device 200. Such a plugging unit 150 may also be electrically connected to the image-forming device 200, via a connector or connection terminal included in the connection unit 140. Alternatively, such a plugging unit 150 may be implemented using a docking structure in which the DMB receiver can be plugged into the image-forming device 200, via a connector or a slide structure.

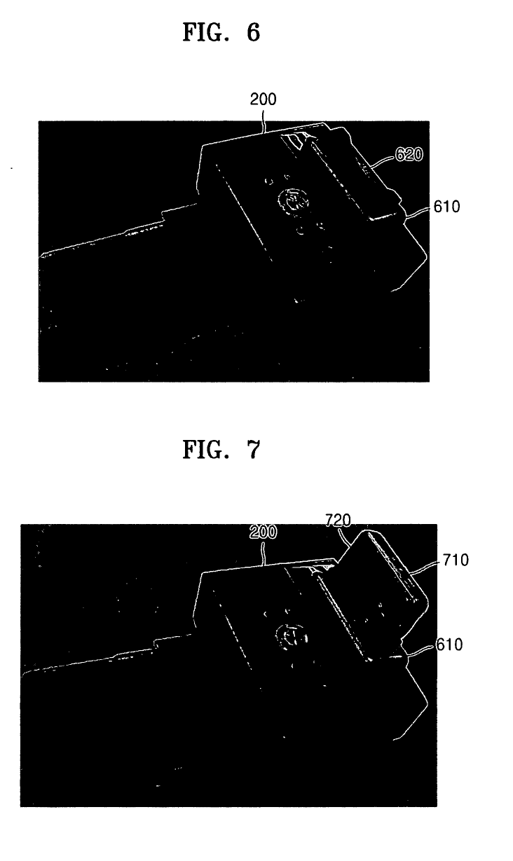

FIG. 6 is a photographic perspective view of an image-forming device having a docking structure built-in for docking a DMB receiver, according to an embodiment of the present invention. As shown in FIG. 6, the image-forming device 200 is provided with a docking structure 610 having a connector 630 in which the DMB receiver can be normally docked thereon.

FIG. 7 is a photographic perspective view of an image-forming device having a docking structure built-in for docking a DMB receiver having a display panel according to an embodiment of the present invention. As shown in FIG. 7, the DMB receiver 710 is provided with a display panel 720, and is mounted onto the docking structure 610 of the image-forming device 200.

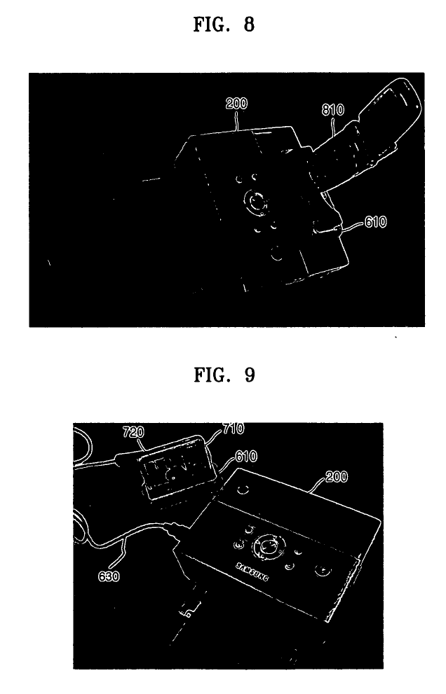

FIG. 8 is a photographic perspective view of an image-forming device having a docking structure 610 and a mobile phone 810 supporting a DMB receiving function mounted on the docking structure, according to an embodiment of the present invention. As shown in FIG. 8, the mobile phone 810 having a DMB receiving function is equipped with the receiving unit 110, the storage medium 129 corresponds to a flash memory or an external memory card, the first selection unit 123 and the second selection unit 130 correspond to a keypad installed in the cellular phone, and the connection unit 140 is connected to and interfaces with the image-forming device 200, via a connector installed in the mobile phone 810.

FIG. 9 is a photographic perspective view of an image-forming device having a separate docking structure connected, via a cable, according to an embodiment of the present invention. As shown in FIG. 9, the separate docking structure 610 and the image-forming device 200 may include USB ports and can be connected to each other using a USB cable.

The invention can also be embodied as computer (including all devices having an information processing function) readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

As described according to embodiments of the present invention, a DMB receiver is portable, converts a predetermined received signal to image data and stores the converted image data in a storage medium, and can be plugged into an image-forming device. In an image-forming system and method, an image-forming device prints image data stored in a storage medium by being connected to the DMB receiver. By doing this, when a user watches broadcasting programs using the DMB receiver, the user can easily capture or record desired scene(s) and store the captured or recorded scene(s) as an image file or a video file. In addition, by connecting the DMB receiver to the image-forming device, image data stored in the storage medium can be easily printed.

Various components of the DMB receiver 100, as shown in FIG. 1, including the receiving unit 110, the first selection unit 123, the second selection unit 130 and the data writer 126, can be implemented in hardware, such as, for example, an application specific integrated circuit (ASIC); however, where appropriate, software, hardware, or a combination thereof can be utilized. Likewise, components of the image-forming device 200, as shown in FIG. 2, including the first selection unit 220 and the second selection unit 230, can be implemented in hardware, such as, for example, an application specific integrated circuit (ASIC). In particular, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, channel tuning, decoding and mixing mechanisms can be incorporated into the receiving unit to perform functions as described in connection with the DMB receiver, as shown in FIG. 1 and FIG. 2. In addition, the receiving unit 110 shown in FIG. 1 can be configured to convert a broadcast signal, which is a RF signal, into an intermediate signal (IF) signal for baseband signal processing. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A digital multimedia broadcasting (DMB) receiver comprising:
a receiving unit arranged to receive DMB signals;
a data storage unit arranged to convert received DMB signals to image data and store converted image data; and
a connection unit arranged to interface with an image-forming device.

2. The DMB receiver as claimed in claim 1, further comprising a plugging unit for enabling the DMB receiver to be plugged into the image-forming device.

3. The DMB receiver as claimed in claim 2, wherein the plugging unit has one of a docking structure, a slide structure, and a built-in structure.

4. The DMB receiver as claimed in claim 1, wherein the data storage unit comprises:
a storage medium for storing image data; and
a data writer for converting the received DMB signals to image data and writing the converted image data to the storage medium.

5. The DMB receiver as claimed in claim 4, wherein the data storage unit further comprises a first selection unit for allowing a user to select one of the received DMB signals to be stored in the storage medium.

6. The DMB receiver as claimed in claim 1, further comprising an external device controller for controlling the image-forming device to print the stored image data.

7. The DMB receiver as claimed in claim 1, further comprising a second selection unit for allowing the user to select image data to be printed among the image data stored in the data storage unit.

8. The DMB receiver as claimed in claim 1, further comprising a display panel for providing a visual display of broadcasting programs corresponding to the received DMB signals, including scenes to be selected by a user for printing operations.

9. The DMB receiver as claimed in claim 1, further comprising an operation panel arranged to enable a user to control operation of the DMB receiver.

10. The DMB receiver as claimed in claim 1, wherein the image data represents a video or image file.

11. The DMB receiver as claimed in claim 1, wherein the DMB receiver is portable.

12. An image-forming system comprising:
a receiving terminal arranged to receive digital multimedia broadcasting (DMB) signals, convert received DMB signals to image data, and store converted image data; and
a printing unit arranged to print image data selected by a user.

13. The image-forming system as claimed in claim 12, wherein the receiving terminal is pluggable.

14. The image-forming system as claimed in claim 13, wherein the receiving terminal is pluggable using one of a docking structure, a slide structure, and a built-in structure.

15. The image-forming system as claimed in claim 12, further comprising a display unit for displaying broadcasting programs from the received DMB signals.

16. The image-forming system as claimed in claim 12, further comprising a first selection unit for allowing a user to select one of the received DMB signals to be stored in a storage medium.

17. The image-forming system as claimed in claim 12, wherein the receiving terminal comprises:
a receiving unit arranged to receive a DMB signal;
a storage medium to store image data; and
a data writer arranged to convert a received DMB signal to image data and write converted image data onto the storage medium.

18. The image-forming system as claimed in claim 17, wherein the printing unit reads and prints image data stored in the storage medium.

19. The image-forming system as claimed in claim 18, further comprising a second selection unit for allowing the user to select one of the image data stored in the storage medium to be printed on a printable medium.

20. The image-forming system as claimed in claim 12, wherein the image data represents a video or image file.

21. An image-forming method comprising:
receiving DMB signals, via a digital multimedia broadcasting (DMB) receiver that is pluggable into an image-forming device;
converting a predetermined signal of the received DMB signals to image data and storing converted image data; and
printing stored image data.

22. The image-forming method as claimed in claim 21, wherein the converted image data is stored in a storage medium included in the DMB receiver.

23. The image-forming method as claimed in claim 21, further comprising providing a visual display of broadcasting programs corresponding to the received DMB signals.

24. The image-forming method as claimed in claim 21, further comprising allowing a user to select one of the received DMB signals to be stored on a storage medium.

25. The image-forming method as claimed in claim 21, wherein the DMB receiver is configured to control the image-forming device to print the stored image data on a printable medium.

26. The image-forming method as claimed in claim 21, wherein the image-forming device reads and prints image data stored in the DMB receiver on a printable medium.

27. The image-forming method as claimed in claim 25, further comprising allowing the user to select one of the stored image data to be printed on the printable medium.

28. The image-forming method as claimed in claim 21, wherein the DMB receiver is pluggable using one of a docking structure, a slide structure, and a built-in structure.

29. The image-forming method as claimed in claim 21, wherein the image data represents a video or image file.

30. A computer readable medium storing a computer readable program for executing the method of claim 21.
